(19) United States
(12) Patent Application Publication
(10) Pub. No.: US 2009/0100070 A1
(43) Pub. Date: Apr. 16, 2009

(54) System and methods for acquiring and handling location-centric information and images

(75) Inventor: Anthony Quartararo, Pinellas Park, FL (US)

Correspondence Address: AKERMAN SENTERFITT, P.O. BOX 3188, WEST PALM BEACH, FL, 33402-3188, US

(73) Assignee: SPATIAL NETWORKS, Clearwater, FL (US)

(21) Appl. No.: 12/152,394

(22) Filed: May 14, 2008

Related U.S. Application Data
(60) Provisional application No. 60/917,697, filed on May 14, 2007.

(51) Int. Cl. G06F 17/30

(52) U.S. Cl. 707/10; 707/102; 707/E17.032; 707/E17.018

(57) ABSTRACT

A computer-based system for collecting, merging, providing, and analyzing location-centric data is provided. The system includes an electronic storage device for electronically storing location-centric data, wherein at least a portion of the location-centric data defines one or more data models. The system also includes a processor communicatively linked to said electronic storage, said processor having an analyzing module configured to analyze user-selected location-centric data based upon the one or more data models, and at least one of a customizing module configured to generate a user-specific data model by modifying at least one of the one or more data models based upon user-supplied specifications, and a new model generating module configured to generate a user-specific data model based upon user-supplied data and specifications. The system further includes a network interface to a data communications network through which a remote computing device can access said processor.

### CROSS-REFERENCE TO RELATED APPLICATIONS

This application claims the benefit of U.S. Provisional Patent Application No. 60/917,697, which was filed May 14, 2007 and which is incorporated herein in its entirety.

### STATEMENT REGARDING FEDERALLY SPONSORED RESEARCH OR DEVELOPMENT

Not applicable.

### FIELD OF THE INVENTION

The present invention is related to the fields of data processing and data communications, and more particularly, to utilizing such processing and networks to facilitate the electronic acquisition, storage, conveyance, merging, and analysis of location-centric data, including visual images corresponding location-specific data.

### BACKGROUND OF THE INVENTION

In an increasingly integrated world, precise geographic information is often critical to solving complex problems having a geospatial dimension. For example, as part of a product marketing campaign, a business might wish to identify and designate optimal geographical locations for positioning billboard advertisements. A relief agency seeking to mobilize limited resources following a national disaster might wish to determine within a region those locations most badly affected by the disaster. Similarly, a municipality seeking to efficiently utilize limited funds to upgrade or expand a public transportation system might wish to determine the most heavily-traveled routes and identify locations where the system needs to be expanded or repaired. These and myriad other examples demonstrate a prevailing need for more effective and more efficient techniques of capturing, merging, maintaining and analyzing disparate pieces of geographic information.

Various types of businesses, not-for-profit organizations, and governmental entities also frequently rely on visual images—pictures and/or recorded video—to make informed operational decisions. A visual image can be used to record an event or existing conditions at a designated location during a specified time. Perhaps more importantly, visual images are frequently utilized by various commercial, not-for-profit, and governmental entities to give the entities a first-hand look at locations of particular interest.

For example, public utilities may analyze visual images of sites where transmission lines are installed to assess what maintenance is needed at each site. Similarly, governmental and relief agencies may analyze visual images to determine the extent of damage following a natural disaster. In these and a host of other contexts, the analysis of visual images can assist various types of managers in making more efficient allocations of resources.

Although it is sometimes said that a picture is worth a thousand words, it is nonetheless often the case that a complete analysis based upon visual images requires that the images be matched to, or merged with, specific types of data, broadly defined as location-centric data. While the task of integrating visual images at a specific location with location-centric data can be done manually, the task can be costly, time consuming, and subject to human error. Accordingly, there is yet the need for some mechanism to more effectively and efficiently capture visual images and link each image to location-centric data pertaining to the locations at which the visual images were captured.

### SUMMARY OF THE INVENTION

The present invention is directed to systems and methods for effectively and efficiently capturing, merging, maintaining, analyzing, and disseminating location-centric data. One objective of the invention is to combine such data with visual images. Another objective is to provide a mechanism for discovering data points pertinent to a particular objective or operation. Still another objective is to provide an efficient mechanism for capturing, maintaining and updating an electronic inventory of location-centric data.

One embodiment of the invention is a computer-based system for collecting, merging, and analyzing location-centric data. The system can include an electronic storage device for electronically storing location-centric data. At least a portion of the location-centric data can define one or more data models. The system also can include a processor communicatively linked to the electronic storage.

The processor, more particularly, can include an analyzing module configured to analyze user-selected location-centric data based upon the one or more data models. The processor also can include a customizing module that is configured to generate a user-specific data model by modifying at least one of the one or more data models based upon user-supplied specifications. Additionally, or alternatively, the processor can include a new-model generating module that is configured to generate a user-specific data model based upon user-supplied data and specifications.

The system, according to this embodiment of the invention, also can include a network interface to a data communications network. The network interface, more particularly, provides an electronic interface, and via the interface, one or more remotely-located computing devices can access the processor of the system.

Another embodiment of the invention is a method, implemented with a mobile electronic device, for acquiring and merging visual images and corresponding location-centric data. The method can include capturing a visual image at a designated location. Additionally, the method can include receiving communication signals conveying location-centric data corresponding to the designated location. The method further can include recording at least one indicator indicating at least one of a date and a time when the visual image was captured.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of an exemplary environment in which a system for collecting, merging, providing, and analyzing location-centric data, according to one embodiment of the invention, is utilized.

FIG. 2 is a schematic view of a processor that, according to another embodiment of the invention, forms part of the system illustrated in FIG. 1.

FIG. 3 is a flowchart of exemplary steps in a method for acquiring and merging visual images and corresponding location-centric data, according to yet another embodiment of the invention.

### DETAILED DESCRIPTION

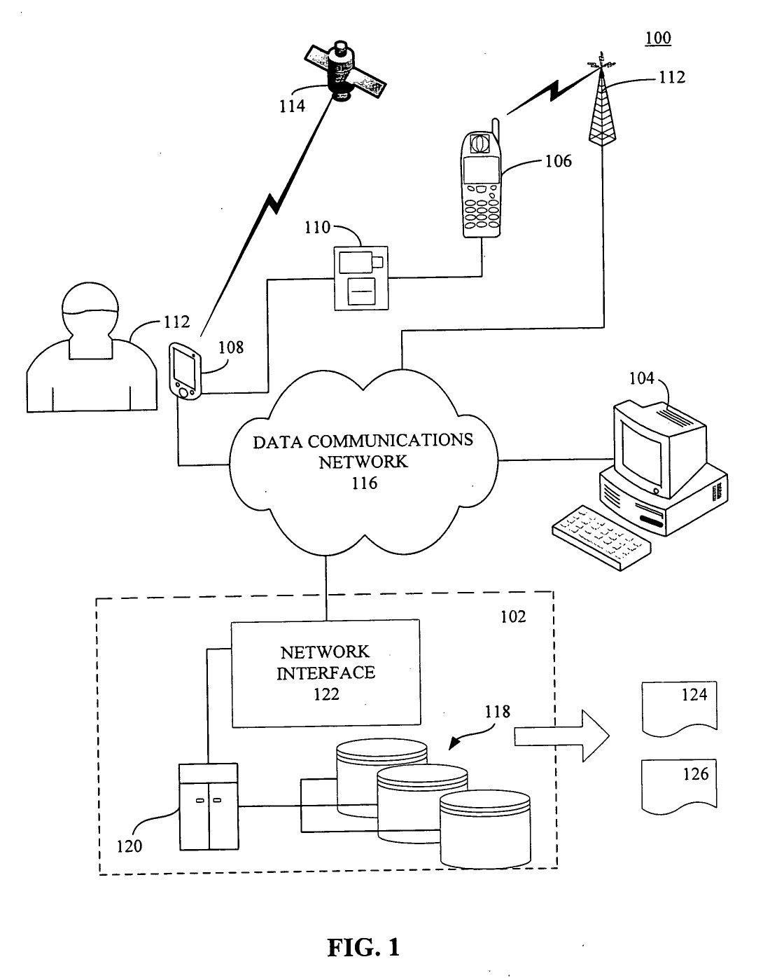

FIG. 1 is a schematic view of an exemplary data communications network environment 100 in which a system 102, according to one embodiment of the invention, can be deployed. As described more particularly below, the system 102 is a networked, computer-based system for collecting, merging, providing, and analyzing visual images and location-centric data. The phrase location-centric data, as used herein, includes data and sets of data that are associated with a defined geographic location. For example, a data point or set of data points indicated by a geographic coordinate reference, such as latitude and longitude, is within the meaning of location-centric data. A data point or set of data points associated with a given time, elevation, and/or degree of precision is likewise within the meaning of location-centric data.

The network environment 100 illustratively includes, in addition to the system 102, a computing device 104, a mobile communications device 106, and/or a portable, handheld device 108. The network environment 100 also illustratively includes a camera 110 for capturing a visual image, either a pictorial image or video recording, at a designated location. The network environment 100, in other embodiments, can include more or fewer such devices, as well as other types of communication and computing devices.

The camera 110 is preferably a digital camera or digital video recorder that captures images not on film, but rather in a digital format using an electronic photosensitive sensor. In a digital format, captured images can be easily downloaded to a computing or communications device having image-processing capabilities. The camera 110 is shown as a separate device that downloads captured images to the mobile communications device 106 or handheld device 108. The captured images can be downloaded to a separate device by “plugging into” the device. Alternately, the captured images can be downloaded by transmitting to the device wireless electromagnetic signals, such as radio frequency or optical signals. For example, the camera 110 and device may each employ a microchip that provides a Bluetooth short-range radio hookup using the 2.4 GHz band. When received by a particular device the wireless signals can be converted into images using signal processing circuitry contained in the device. Although shown as a distinct device, it will be apparent to one of ordinary skill in the art that alternately the camera 110 can be a component integrated with computing or communications circuitry and housed within the mobile communications device 106 or handheld device 108.

The at least one computing device 104 is illustrated as a desktop computer. In other embodiments, however, the computing device 104 can be, additionally or alternatively, a laptop computer or similar type of device with which a user can input information using a computer keyboard or a computer mouse to effect point-and-click operations, for example.

The at least one mobile communications device 106 is illustratively a cellular phone that communicates via a cellular network by wireless signals transmitted to and received from one or more cellular towers 112 linked to base stations of the cellular network. The cellular network can be communicatively linked to the system 102 directly and/or via a computer communications network. Additionally or alternatively, the mobile communications device 106 can communicate, for example, via a communications satellite or over a mobile communication network.

The handheld device 110 can be, for example, a personal digital assistant (PDA), electronic tablet, or similar such device. Thus, the handheld device 110 can incorporate handwriting-recognition and/or speech-recognition features, allowing a user 112 to input information to the system 102 in written and/or spoken form.

The various computing and communications devices shown, moreover, can each be “location aware,” as will be readily understood by one of ordinary skill in the art. For example, the cellular network through which the mobile communications device 106 communicates can be configured to determine the device's geographic location whenever the device is within the range of a cellular tower 112 of the network. Alternately, as illustrated with respect to the handheld device 110, a device can include a Global Positioning System (GPS) receiver through which location information can be received from a GPS satellite 114

Each of the various devices shown in the exemplary network environment 100 is illustratively linked to the system 102 via a data communications network 116. The data communications network can comprise the Internet, a wired or wireless wide area network (WAN), a wired or wireless local area network (LAN), or any other network configured to convey packetized data between the system 102 and the various network-connected devices 104-110, according to one or more known routing protocols. Although illustratively shown as being connected to the system 102 via the data communications network 116, in alternate embodiments one or more of the different devices connects directly to the system 102.

The system 102 illustratively comprises one or more electronic storage devices 118 for electronically storing one or more databases containing location-centric data. According to the invention, the electronically stored data also can comprise data that defines one or more data models that can be used as a basis for analyzing location-centric data. The system 102 also illustratively includes a processor 120. The processor 120 is communicatively linked to the electronic storage devices 118.

Although, the electronic storage devices 118 and processor 120 are shown as being collocated, in an alternate embodiment one or more of the storage devices 118 can be located remotely from the processor 120. In this alternative embodiment, one or more of the remotely-located storage devices 118 can be accessed by the processor 120 through the data communications network 116. Accordingly, a remotely-located storage device can store a database that is maintained by an entity that is distinct from the entity that operates the system 102. The database can be a publicly-accessible database or, alternatively, the database can be a proprietary database for which the entity that operates the system 102 pays a fee for accessing the database. As described more particularly below, one aspect of the invention is that the processor can implement a search function to search for and retrieve from remotely-located databases location-centric data according to specified search parameters.

Additionally, the system 102 illustratively includes a network interface 122 through which the system accesses the exemplary data communications network 116. Via the network interface 122 the system 102 communicates with one or more of the network-connected devices 104, 106, 108. Thus, the network interface provides access to any communication or computing device that communicates through the data communications network 116. As described more particularly below, this enables the system 102 to be utilized as an on-line subscription service in which end users and subscribing system administrators are able to access the functionality of the system.

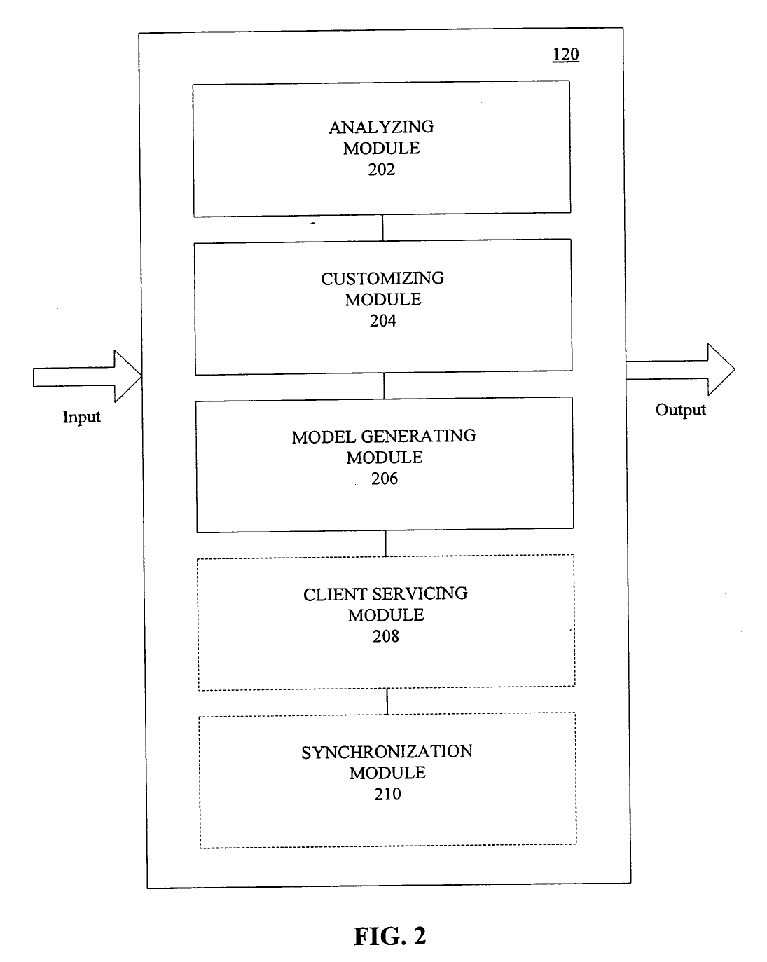

Referring additionally now to FIG. 2, a schematic view of a particular embodiment of the processor 120 is provided. The processor 120 illustratively includes an analyzing module 202, as well as a customizing module 204 and a model generating module 206. Each of the modules 202, 204, 206 can be implemented in dedicated, hardwired circuitry. Alternatively, each of the modules 202, 204, 206 can be implemented in computer-readable code configured to execute on a general-purpose or application-specific computing device. According to yet another embodiment, each of the modules 202, 204, 206 can be implemented as a combination of hardwired circuitry and computer-readable code. Preferably, however, the analyzing module 202, customizing module 204, and model generating module 206 are each implemented as computer-readable code configured to run on any computing device having logic-based circuitry, such as registers and logic gates (not shown), for executing the code.

Operatively, the analyzing module 202 is configured to analyze user-selected, location-centric data. The analyzing module 202 can analyze location-centric data by applying one or more of the data models stored in at least one of the electronic storage devices 118. The analyzing module, more particularly, can be configured to apply various data models constructed on the basis of “best practices” uniquely associated with different types of entities that utilize location-centric data for distinct purposes.

Another aspect of the invention is a capability that permits users to customize the various data models to meet specific needs and objectives. Accordingly, the customizing module 204 is configured to generate a user-specific data model by modifying at least one of the data models based upon user-supplied specifications. An individual or organizational entity, more particularly, can provide specifications that the customizing module 204 applies so as to modify one or more stored data models to meet a specific objective or suite a particular purpose of the individual user or organization.

Yet another aspect of the invention is that it permits users to generate their own, user-specified data models. Specifically, the model generating module 206 is configured to generate a user-specific data model based upon user-supplied data and/or specifications.

An exemplary data model, exemplifying many other models that can be utilized by the system 102, is a data model pertaining to a cellular telephone network. The model can be used in allocating resources to maintain the antenna towers comprising the network. Pertinent data could be obtained from input supplied by, for example, individuals or crews using a PDA or other electronic device. Additionally, or alternatively, data could be obtained by searching and retrieving information from various publicly-available and/or fee-based, on-line databases.

The described operative features of the system 102 are thus able to capture and merge information about the cellular network. In particular, the system 102 is able to collect information about the location of the cellular towers, as well information such as the elevation and site-specific attributes of each antenna. The system 102 also, through the operative features already described, can update local or remotely-located databases with periodically- or intermittently-collected information, such as the strength of signals transmitted by each antenna, physical condition of each antenna and corresponding equipment, as well as the time and/or date such information was collected. The system 102 can display the various location-centric data on a map, such as a thematic map. The juxtaposition of the map and the location-centric data, specified according to a user's specific purpose, can be analyzed. For example, each of the cellular towers could be displayed on the map, with each particular tower identified as being in need of repair appearing in red.

As already noted, the system 102 can be used to implement an on-line subscription service. The system 102, more particularly, can provide a mechanism whereby users, as service subscribers, are able to integrate wireless signaling of geographic location data (determined, for example, with a GPS receiver) with other data such as visual images captured by a digital camera and downloaded to a PDA or other electronic device. The electronic device can convey the data and corresponding images to the system 102. The system 102 can match the captured images to one or more particular locations and other location-centric data corresponding to locations where the images were captured.

As described herein, the system 102 further allows subscribers to manage data collection tasks. The tasks can include, for example, defining required fields for data collection, constructing list boxes to standardize data entry for the fields, as well as exporting and importing user-defined data collection projects conveyed to the system using a PDA or other electronic device. Thus, using a PDA or other electronic device as described above, a user is able to access the system 102 and through the system collect GPS coordinates, capture standardized attributes with the PDA or other electronic device, and/or link visual images. The collected GPS and attribute data can be stored in a file, such as an extensible markup language (XML) file, and electronically linked to one or more corresponding visual images. The XML files can be readily transferred to a user-selected database or converted to a format utilized by a geographic information system (GIS) available to the user.

According to another embodiment of the invention, the processor 202 optionally includes a client servicing module 208. The client servicing module 208 executes on the processor and is configured to generate user-specific software and/or data collection forms. Executing on the processor 202, the client servicing module 208 generates user-specific software—that is, processor-executable code tailored to a particular user—and/or data collection forms based upon user-supplied specifications.

Still another aspect of the invention is that user-specific software and/or data collection forms so generated by the client servicing module 208 can be downloaded a mobile electronic device. The download can be to various types of mobile electronic devices, including the computing device 104, the mobile communications device 106, and/or the portable, handheld device 108. The network interface 122, according to this embodiment of the invention, is configured to convey via the data communications network 116 the user-specific software and/or data collection forms for downloading to various types of mobile electronic devices.

With the system 102 utilized as an on-line subscription service through which users can download user-specific software and/or data collection forms to a mobile device, the system can be configured to provide yet additional functionality. Specifically, the system 102 can be synchronized with respect to different user's mobile devices to which user-specific software and/or data collection forms have already been downloaded. According to another embodiment of the invention, the processor 120 optionally comprises a synchronization module 210. The synchronization module 210 is configured to synchronize the system with any one of a user's remote data collection devices.

Still another functionality provided to users of the system 102, is the presentation of analyses performed by the analyzing module 202. The analyzing module, according to this embodiment, is further configured to provide an analysis of user-selected, location-centric data in a graphical, tabular, or other type of format. In a graphical or tabular format, the system 102 can convey to a remotely-located computing or communication device having a visual display graphical and/or tabular results of the analysis. When so conveyed the results can be displayed on the visual display of a device. The results also can be formatted by the analyzing module 202 so that the results can be utilized with at least one software mapping tool that executes on the remotely-located computing or communication device.

As described herein, the system operatively provides a mechanism whereby new location-centric data is discovered (e.g., the locations of cellular towers that are in need of maintenance). Secondly, the system 102 provides a mechanism for creating an inventory of location-centric data. For example, geographic location of a cellular tower site may be known, but additional information may be desirable, such as the last time that maintenance was performed on the cellular tower at a particular site. Alternatively, asset identity and/or asset condition may be known, but not the corresponding location (e.g., the precise location of each item of a set of construction equipment). Thirdly, the system 102 provides a mechanism for updating the inventory of location-centric data.

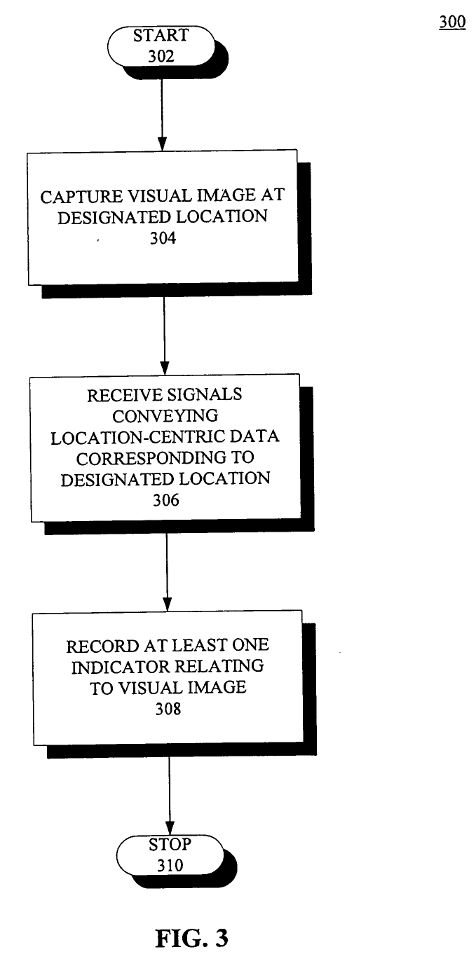

FIG. 3 is a flowchart of exemplary steps for implementing a method 300 for acquiring and merging visual images and corresponding location-centric data, according to yet another embodiment of the invention. The method 300 can be implemented, for example, within a mobile electronic device. After starting at block 302, the method also illustratively includes capturing a visual image at a designated location at block 304. Additionally, at block 306, the method 300 illustratively includes receiving communication signals conveying location-centric data corresponding to the designated location. The method further illustratively includes recording, at block 308, at least one indicator pertaining to the captured visual image. The one or more indicators can indicate a date and/or a time when the visual image was captured. The method 300 illustratively concludes at block 310.

According to one embodiment, the method 300 further comprises receiving processor-executable code with a mobile electronic device, such as a portable computing or communications device. The code, more particularly, is configured to execute on a processor of the mobile electronic device. When executed by the processor, the code causes the mobile electronic device to perform at least one of the capturing, receiving, and recording steps of the method 300.

The capturing step can be performed with a camera or video device that is separate from and operates independently of the mobile electronic device. Accordingly, the method 300 can further include conveying the visual image from the camera or video device to the mobile electronic device subsequent to capture of the visual image. In an alternative embodiment, however, the capturing step, illustrated at block 304, can be performed with a camera or video device that is an integrated component of the mobile electronic device.

The step of receiving, illustrated at block 306, can include receiving communication signals conveying location-centric data, which comprises a latitude, longitude, or elevation of the designated location. As already noted, location-centric data indicating geographical position can be obtained by a mobile communication device communicating through a location-aware cellular network. Alternatively, or additionally, location-centric data indicating a geographical position can be obtained by a mobile electronic device having a GPS receiver.

### EXAMPLES

An exemplary use of the invention is with respect to a municipality that has allocated finds for a project to repair sidewalks. Maintenance crews or any city employee equipped with a mobile electronic device could mark all incidents of sidewalks in need of repair. This could be easily plotted on a map and a plan for repair cold be drawn up based on the density of incidents or the heaviest traffic patterns.

Another exemplary use of the invention pertains to the repair of highway guard rails or medians. Repairs could easily be planned by highway personnel, such as highway patrol officers or DOT employees, noting with electronic mobile devices highway conditions at specified locations as they traverse the highway system in the course of their normal work. A repair plan could then be devised based on the identified locations were work is needed and resources could be allocated.

Still another exemplary use of the invention is for park maintenance. Park rangers could use one or more types of mobile electronic devices described herein to identify and record the conditions of hiking trails as they come across them. Points were problems are noted could then be electronically plotted and mapped for viewing. The map could then be viewed by visitors before they begin hiking, or used by park rangers to identify where warning signs should be posted. The map also could be used to plan repair work.

Yet another exemplary use of the invention is by a marketing company. The marketing company can use the invention to identify optimal locations, based on location-centric data, for advertising on different highway billboards.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, such as magnetic tape or optical disk, in which is embedded computer-executable code that is configured to implement the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-based system for collecting, merging, providing, and analyzing location-centric data, the system comprising:
an electronic storage device for electronically storing location-centric data, wherein at least a portion of the location-centric data defines one or more data models;
a processor communicatively linked to said electronic storage, said processor having
an analyzing module configured to analyze user-selected location-centric data based upon the one or more data models, and at least one of
a customizing module configured to generate a user-specific data model by modifying at least one of the one or more data models based upon user-supplied specifications, and
a new model generating module configured to generate a user-specific data model based upon user-supplied data and specifications; and
a network interface to a data communications network through which a remote computing device can access said processor.

2. The computer-based system of claim 1, wherein the processor further comprises a client servicing module configured to generate user-specific software and data collection forms based upon user-supplied specifications.

3. The computer-based system of claim 2, wherein the network interface is configured to convey via the data communications network the user-specific software and data collection forms for downloading to a mobile electronic device.

4. The computer-based system of claim 3, wherein the mobile electronic device comprises a data collection device, and wherein the processor further comprises a synchronization module configured to synchronize the system with a remote data collection device.

5. The computer-based system of claim 1, wherein the analyzing module is further configured to provide an analysis of user-selected location-centric data in a graphical or tabular format that when conveyed to remotely-located computing device having a visual display can be displayed on the visual display and utilized with at least one software mapping tool that executes on the remotely-located computing device.

6. A method, implemented with a mobile electronic device, for acquiring and merging visual images and corresponding location-centric data, the method comprising:
capturing a visual image at a designated location;
receiving communication signals conveying location-centric data corresponding to the designated location; and
recording at least one indicator indicating at least one of a date and a time when the visual image was captured.

7. The method of claim 6, further comprising receiving processor-executable code that executes on a processor of the mobile electronic device, wherein when executed by the processor the code causes the mobile electronic device to perform at least one of the capturing, receiving, and recording steps.

8. The method of claim 7, wherein the capturing step is performed with a camera or video device that is separate from and operates independently of the mobile electronic device, and further comprising conveying the visual image from the camera or video device to the mobile electronic device subsequent to capture of the visual image.

9. The method of claim 7, wherein the capturing step is performed with a camera or video device that is an integrated component of the mobile electronic device.

10. The method of claim 6, wherein the step of receiving comprises receiving communication signals conveying location-centric data comprising at least one of a latitude, longitude, and elevation of the designated location.
